(19) United States
(12) Patent Application Publication
(10) Pub. No.: US 2012/0038569 A1
(43) Pub. Date: Feb. 16, 2012

(54) INPUT DEVICE, INPUT METHOD FOR INPUT DEVICE AND COMPUTER READABLE MEDIUM

(75) Inventors: Kazuyasu YAMANE, Tokyo (JP); Koji Nishitani, Tokyo (JP)

(73) Assignee: CASIO COMPUTER CO., LTD., Tokyo (JP)

(21) Appl. No.: 13/204,809

(22) Filed: Aug. 8, 2011

(30) Foreign Application Priority Data
Aug. 13, 2010 (JP) P2010-181197

(51) Int. Cl. G06F 3/041

(52) U.S. Cl. 345/173; 345/156

(57) ABSTRACT

There is provided an input device that includes: a display configured to display information on a screen; a detector configured to detect a user input operation in a detectable region of the detector and acquire position coordinates of the user input operation, wherein the detectable region is larger than a display region of the display, and the display region is included in the detectable region; and a controller configured to transform the position coordinates of the user input operation, wherein when the detector detects the user input operation in the detectable region other than the display region and acquires position coordinates of the user input operation, the controller transforms the position coordinates into position coordinates corresponding to a certain position in the display region.

### CROSS-REFERENCE TO RELATED APPLICATION

This application claims priority from Japanese Patent Application No. 2010-181197, filed on Aug. 13, 2010, the entire contents of which are hereby incorporated by reference.

### BACKGROUND

1. Technical Field

Embodiments described herein relate to an input device, an input method for the input device and a computer readable medium.

2. Related Art

A touch panel type display input device (hereinafter referred to as “touch panel” simply) has been recently provided as one form of a display and input device of a computer. The touch panel has a display device, and an input device which detects a direct operation (such as a pressing operation, a touching operation, an approaching operation etc.) on a display region of the display device. Contents of the operation detected by the input device are associated with contents displayed by the display device, so that the contents of the operation are processed as a predetermined input operation. For example, a subject performing operation on the display region is an exclusive device (such as a touch pen, etc.), a human finger, or the like.

There has been provided also a touch panel in which an input operation on predetermined coordinates detected by an input device of the touch panel is associated with a specific control command so that the input operation is diversified (see e.g. JP-A-05-046315).

The related-art touch panel however may often hardly perform an input operation on an outer circumference of the display region or the vicinity of the outer circumference.

For example, in a touch panel having a rectangular display region, when a user intends to perform an input operation (touch) on an input operation target (such as an icon, a button, etc.) disposed closely to the outer circumference (four apexes, four sides, etc.) of the display region, the user may touch the outside of the display region out of input detection area of the touch panel by mistake. In this case, the user has to perform the input operation correctly again because the mistaken input operation cannot be accepted. In this manner, in the related-art touch panel, it is difficult to operate an input operation target disposed in the outer circumference of the display region or the vicinity of the outer circumference. Such a problem may occur not only in the rectangular display region but also in any shape display region.

### SUMMARY

Exemplary embodiments perform an input operation well on an outer circumference of a display region or the vicinity of the outer circumference.

According to one or more illustrative aspects of the present invention, there is provided an input device that includes: a display configured to display information on a screen; a detector configured to detect a user input operation in a detectable region of the detector and acquire position coordinates of the user input operation, wherein the detectable region is larger than a display region of the display, and the display region is included in the detectable region; and a controller configured to transform the position coordinates of the user input operation. When the detector detects the user input operation in the detectable region other than the display region and acquires position coordinates of the user input operation, the controller transforms the position coordinates into position coordinates corresponding to a certain position in the display region. When the detector detects the user input operation in the display region and acquires position coordinates of the user input operation, the controller sets the acquired position coordinates as position coordinates of the user input operation without transforming the acquired position coordinates.

Other aspects and advantages of the present invention will be apparent from the following description, the drawings and the claims.

### BRIEF DESCRIPTION OF THE DRAWINGS

Exemplary embodiments of the present invention will be described in detail based on the following figures, wherein:

FIG. 1 is a block diagram showing the main configuration of a portable terminal having an input device according to an exemplary embodiment of the invention;

FIG. 2 is a view showing an example of external appearance of the portable terminal;

FIG. 3 is a view showing the relation between the size of a display region of a display and the size of a detection region of a detector;

FIG. 4 is a view showing an example of the display region divided into compartments by a width of m in an X direction and by a width of n in a Y direction;

FIG. 5 is a view showing an example of division of the detection region; and

FIG. 6 is a flow chart to explain XY coordinate transformation processing performed by a CPU based on XY coordinates provided from the detector.

### DETAILED DESCRIPTION OF EXEMPLARY EMBODIMENTS

Hereinafter, exemplary embodiments of the present invention will be now described with reference to the drawings. It should be noted that the scope of the invention is not limited to the illustrated example.

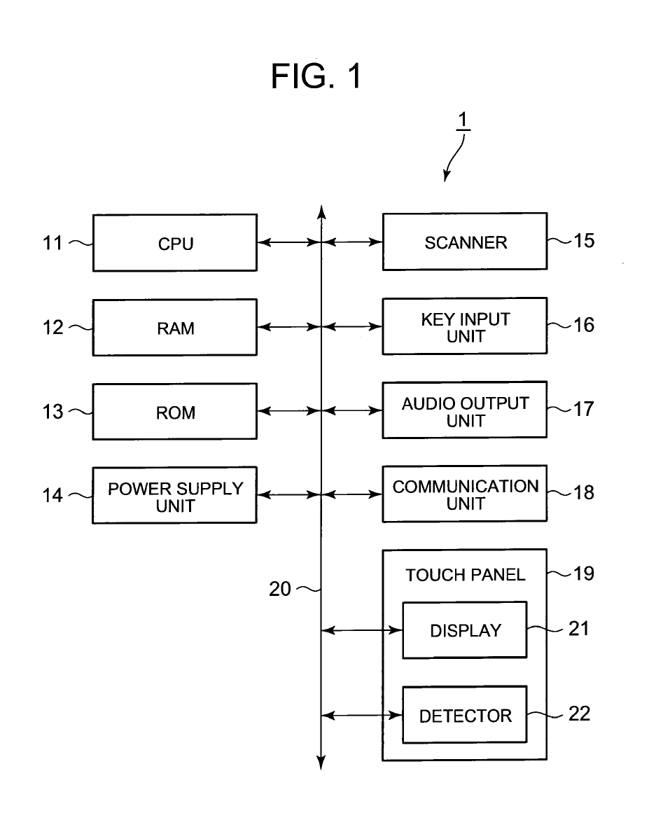

FIG. 1 shows the main configuration of a portable terminal 1 including an input device according to an exemplary embodiment of the invention.

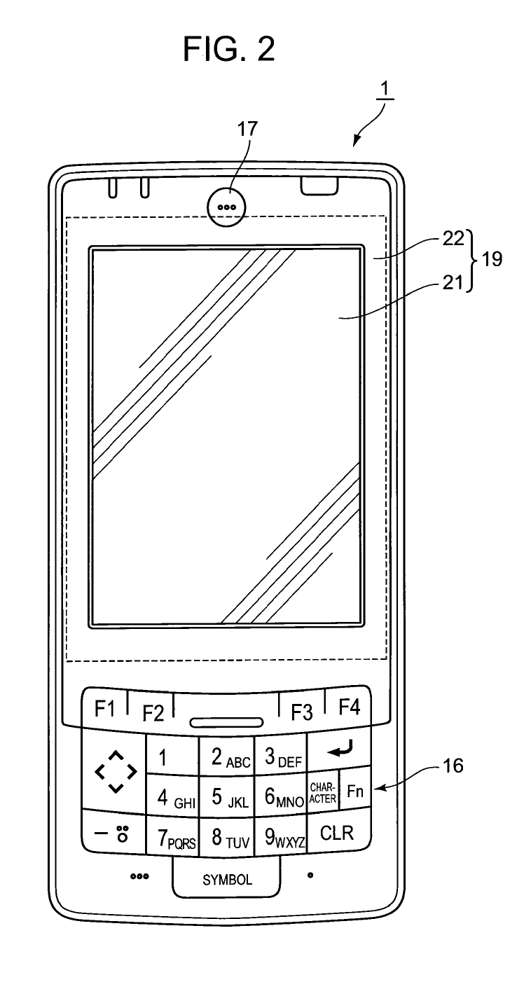

FIG. 2 shows an example of external appearance of the portable terminal 1.

The portable terminal 1 includes a CPU 11, an RAM 12, an ROM 13, a power supply unit 14, a scanner 15, a key input unit 16, an audio output unit 17, a communication unit 18, and a touch panel 19. These respective elements are connected to one another by a bus 20.

The CPU 11 works with a program stored in the ROM 13 to control the operation of the portable terminal 1 in accordance with a program, data, etc. expanded on the RAM 12.

The RAM 12 stores data expanded by the CPU 11, data temporarily generated by the expansion processing.

The ROM 13 stores a program or data read out by the CPU 11, for example.

The power supply unit 14 supplies electric power to the respective elements of the portable terminal 1. The portable terminal 1 has a rechargeable secondary battery such as a lithium ion battery. The power supply unit 14 supplies electric power stored in the secondary battery to the respective elements. The power supply unit 14 may be configured to charge the secondary battery or an external power supply may be connected to the power supply unit 14.

The scanner 15 scans a readout target and generates readout data based on a change of an electric signal obtained by the scanning For example, the scanner 15 is a barcode scanner. However, another reading device may be used as the scanner 15.

The key input unit 16 is an input device having keys (buttons) to which input contents are allocated individually. A user can perform any input by selecting a key to be operated in accordance with input contents allocated to each key.

The audio output unit 17 outputs audio in accordance with contents of processing performed by the CPU 11. The audio to be outputted may be audio based on audio data stored in the ROM 13 in advance or may be audio based on audio data inputted from the outside through the communication unit 18, etc.

The communication unit 18 communicates with an external device. The communication unit 18 has a communication device such as a network interface card (NIC) which performs data transmission with the external device through a line. Although data transmission is performed by the communication unit 18 without regard to wire/wireless and protocols and other connection formats (such as standards, etc.) for the wire/wireless, the communication unit 18 can communicate with the external device by wireless LAN (Local Area Network) communication.

The touch panel 19 includes a display 21 and a detector 22.

The display 21 is a display device such as a liquid crystal display, an organic electro-luminescence (EL) display, which displays information on a screen in accordance with contents of processing performed by the CPU 11. The display 21 is configured to display information on a screen. Another display device than the exemplified display devices may be used as the display 21. Although this exemplary embodiment shows the case where the display 21 has a rectangular display region surrounded by sides along either of two directions (e.g. an X direction and a Y direction shown in FIG. 2, etc.) meeting each other at right angles, the shape of the display region of the display 21 is not limited thereto but can be designed arbitrarily.

The detector 22 detects an input operation (such as a pressing operation, a touching operation, an approaching operation, etc.) on the display region displayed on a screen by the display 21. For example, the detector 22 is configured to cover the display region of the display 21, and detects the position of an operation (touching or approaching operation) applied on the touch panel 19 by one of various methods such as a resistive film method, an ultrasonic surface acoustic wave method, a capacitance method, etc. For outputting a result of detection of an operating position, for example, the detector 22 outputs a result of detection of the operating position as position information in predetermined coordinates. In this exemplary embodiment, the detector 22 outputs a result of detection of the operating position as XY coordinates determined based on the X and Y directions. The method used by the detector 22 for detecting the operating position is only one instance, and the method may be suitably changed to another method capable of detecting the contents of the operation applied on the display region of the display 21.

The CPU 11 recognizes the contents of the input operation applied on the touch panel 19 based on correspondence between the contents of the operation detected by the detector 22 and the contents displayed on the display 21.

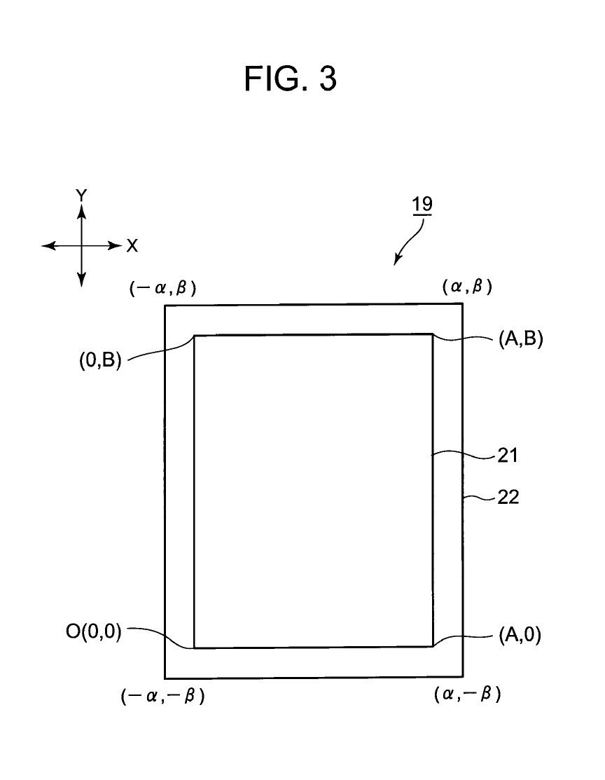

FIG. 3 shows the relation between the size of the display region of the display 21 and the size of the detection region of the detector 22.

As described above, the touch panel 19 is formed so that an input operation on the display region of the display 21 is detected by the detector 22. As shown in FIG. 3, the detection region where the operating position is detected by the detector 22 is larger than the display region where the screen is displayed by the display 21. That is, the detector 22 is configured to detect coordinates of an input operation at least on the outside of the display region of the display 21.

In this exemplary embodiment, the CPU 11 examines correspondence between the display region of the display 21 and the detection region of the detector 22 based on XY coordinates using one (e.g. lower left apex O shown in FIG. 3) of apexes of a rectangle forming the outer circumference of the display region of the display 21, as a reference point (origin).

In FIG. 3 and the following description, let (0, 0) be XY coordinates of the apex O and (A, B) be XY coordinates of an apex which is located on the outer circumference of the display region of the display 21 so as to be opposite to the apex O. Then, (A, 0) and (0, B) are XY coordinates of two apexes which are located on the outer circumference of the display region of the display 21 so as to be adjacent to the apex O and the apex opposite to the apex O, respectively. Incidentally, the detector 22 has a rectangular display region surrounded by sides along either of two directions (e.g. X and Y directions) meeting each other at right angles in the same manner as the display region of the display 21. Each X-direction side of four sides which form the outer circumference of the detection region of the detector 22 is 2α longer than each X-direction side of the display region of the display 21. Each Y-direction side of four sides which form the outer circumference of the detection region of the detector 22 is 2β longer than each Y-direction side of the display region of the display 21. The display region of the display 21 is located in the center of the detection region of the detector 22 with respect to the X and Y directions. That is, XY coordinates of apexes of the detection region of the detector 22 relative to the XY coordinates (0, 0) of the apex O of the display region of the display 21 are (−α, −β), (A+α, −β), (−α, B+β) and (A+α, B+β) respectively. In the example shown in FIG. 3, coordinates of the nearest apex of the detection region to the apex O are (−α, −β), coordinates of the neatest apex of the detection region to the apex with the XY coordinates (A, 0) are (A+α, −β), coordinates of the nearest apex of the detection region to the apex with the XY coordinates (0, B) are (−α, B+β), and coordinates of the nearest apex of the detection region to the apex located on the outer circumference of the display region of the display 21 so as to be opposite to the apex O are (A+α, B+β).

A process of examining correspondence between the display region of the display 21 and the detection region of the detector 22 based on the operating position detected by the detector 22 will be now described.

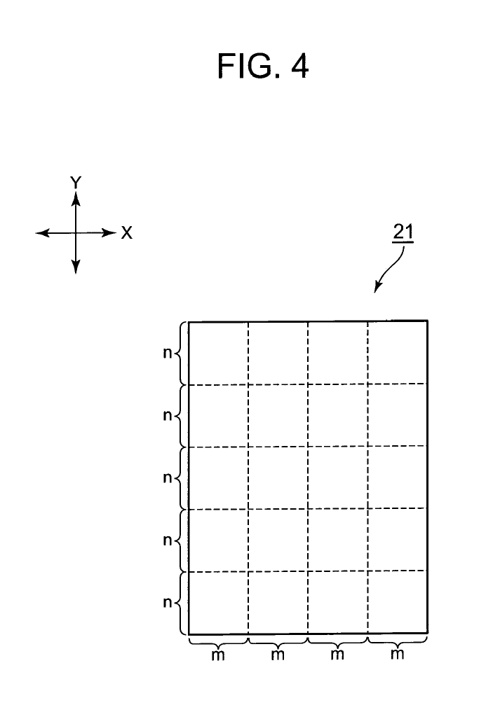

FIG. 4 shows an example of the display region of the display 21 divided into compartments by a width of m in the X direction and by a width of n in the Y direction. In FIG. 4, m and n are predetermined numerical values based on XY coordinates.

For example, as shown in FIG. 4, the CPU 11 provides predetermined small compartments in the display region of the display 21. For example, a short cut icon or the like for a program can be provided in each small compartment on the display screen. Although FIG. 4 shows small compartments obtained by dividing the display region of the display 21 by the width of m in the X direction and by the width of n in the Y direction, the size of each small compartment and the number of small compartments can be set arbitrarily. In addition, m and n may have the same value or may have different values.

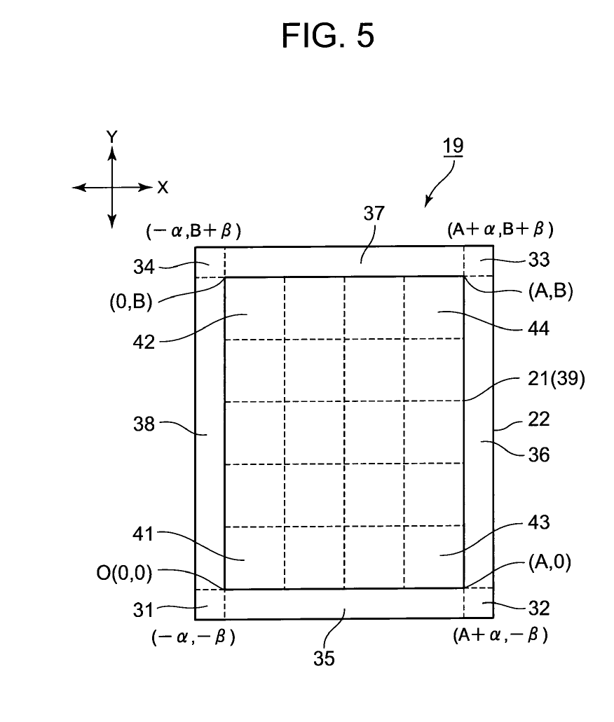

FIG. 5 shows an example of division of the detection region.

The CPU 11 manages the detection region of the detector 22 by dividing the detection region of the detector 22 into plural regions. In the following description, the regions into which the CPU 11 divides the detection region of the detector 22 are referred to as “split regions”. The split regions are distinguished based on positions relative to the display region of the display 21. In other words, the CPU 11 divides the detection region based on positions relative to the display region of the display 21.

In this exemplary embodiment, as shown in FIG. 5, the detection region is divided into nine split regions based on four sides connecting adjacent apexes of four points with XY coordinates (0, 0), (A, 0), (0, B) and (A, B) corresponding to apexes of the display region of the display 21 so as to correspond to the outer circumference of the display region and lines obtained by extending the four sides to the detection region of the detector 22.

In the following description, as shown in FIG. 5, in the XY coordinates, a split region in a range of (−α, −β) to (0, 0) is regarded as split region 31, a split region in a range of (A, −β) to (A+α, 0) is regarded as split region 32, a split region in a range of (A, B) to (A+α, B+β) is regarded as split region 33, a split region in a range of (−αa, B) to (0, B+β) is regarded as split region 34, a split region in a range of (0, −β) to (A, 0) is regarded as split region 35, a split region in a range of (A, 0) to (A+α, B) is regarded as split region 36, a split region in a range of (0, B) to (A, B+β) is regarded as split region 37, a split region in a range of (−α, 0) to (0, B) is regarded as split region 38, and a split region corresponding to the detection region except the split regions 31 to 38, that is, a split region corresponding to the inside of the display region of the display 21 is regarded as split region 39.

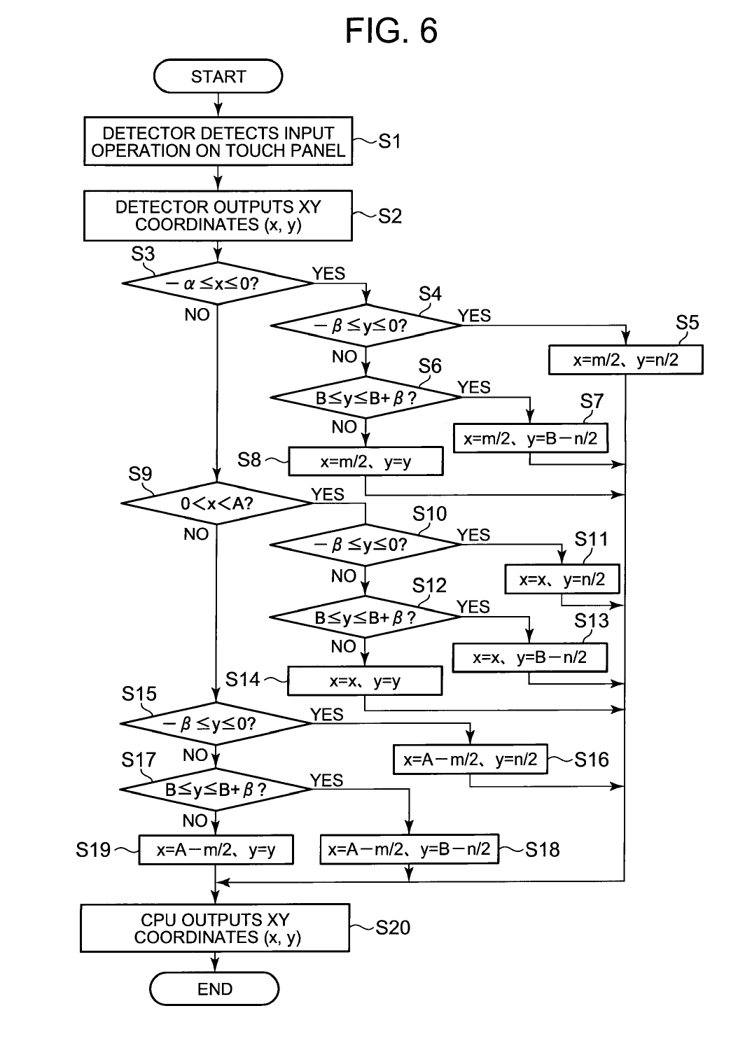

FIG. 6 is a flow chart to explain XY coordinate transformation processing performed by the CPU 11 based on XY coordinates outputted from the detector 22.

The CPU 11 determines a split region on which an input operation is performed, based on XY coordinates outputted from the detector 22. When the split region on which the input operation is performed is another split region than the split region 39, the CPU 11 transforms the X coordinate, the Y coordinate or the XY coordinates.

In this exemplary embodiment, when an input operation on the touch panel 19 is first detected by the detector 22 (step S1), XY coordinates of a result of the detection are outputted from the detector 22 (step S2). Let (x, y) be the XY coordinates outputted by processing in the step S2. The CPU 11 determines whether the X coordinate value (x) in the input XY coordinates satisfies −α≦x≦0 or not (step S3).

When it is concluded in the step S3 that the X coordinate value (x) satisfies −α≦x≦0 (step S3: YES), the CPU 11 determines whether the Y coordinate value (y) in the XY coordinates outputted from the detector 22 satisfies −β≦y≦0 or not (step S4).

When it is concluded in the step S4 that the Y coordinate value (y) satisfies −β≦y≦0 (step S4: YES), the CPU 11 transforms the coordinates subjected to the input operation into (m/2, n/2) (step S5).

The case where it is concluded in the step S4 that the Y coordinate value (y) satisfies −β≦y≦0 (step S4: YES) means the case where the input operation is performed on the split region 31. In this case, the CPU 11 performs processing in the step S5 to transform the coordinates subjected to the input operation into (m/2, n/2) so that the input operation performed on the split region 31 is regarded as an input operation performed on a small compartment in the display region (small compartment 41 shown in FIG. 5) which is the nearest to the XY coordinates (0,0) of the apex O and adjacent to the outer circumference of the display region.

On the other hand, when it is concluded in the step S4 that the Y coordinate value (y) does not satisfy −β≦y≦0 (step S4: NO), the CPU 11 determines whether the Y coordinate value (y) in the XY coordinates outputted from the detector 22 satisfies B≦y≦B+β or not (step S6).

When it is concluded in the step S6 that the Y coordinate value (y) satisfies B≦y≦B+β (step S6: YES), the CPU 11 transforms the coordinates subjected to the input operation into (m/2, B−n/2) (step S7).

The case where it is concluded in the step S6 that the Y coordinate value (y) satisfies B≦y≦B+β (step S6: YES) means the case where the input operation is performed on the split region 34. In this case, the CPU 11 performs processing in the step S7 to transform the coordinates subjected to the input operation into (m/2, B−n/2) so that the input operation performed on the split region 34 is regarded as an input operation performed on a small compartment in the display region (small compartment 42 shown in FIG. 5) which is the nearest to the XY coordinates (0, B) and adjacent to the outer circumference of the display region.

On the other hand, when it is concluded in the step S6 that the Y coordinate value (y) does not satisfy B≦y≦B+β (step S6: NO), the CPU 11 transforms the coordinates subjected to the input operation into (m/2, y) (step S8).

The case where it is concluded in the step S6 that the Y coordinate value (y) does not satisfy B≦y≦B+β (step S6: NO) means the case where the input operation is performed on the split region 38. In this case, the CPU 11 performs processing in the step S8 to transform the coordinates subjected to the input operation into (m/2, y) so that the input operation performed on the split region 38 is regarded as an input operation performed on a small compartment which is the nearest to (x, y) in small compartments provided in the display region so as to be arranged along a side connecting the XY coordinates (0, 0) and (0, B) and which is adjacent to the outer circumference of the display region.

When it is concluded in the step S3 that the X coordinate value (x) does not satisfy −α≦x≦0 (step S3: NO), the CPU 11 determines whether the X coordinate value (x) satisfies 0<x<A or not (step S9).

When it is concluded in the step S9 that the X coordinate value (x) satisfies 0<x<A (step S9: YES), the CPU 11 determines whether the Y coordinate value (y) in the XY coordinates outputted from the detector 22 satisfies −β≦y≦0 or not (step S10).

When it is concluded in the step S10 that the Y coordinate value (y) satisfies −β≦y≦0 (step S10: YES), the CPU 11 transforms the coordinates subjected to the input operation into (x, n/2) (step S11).

The case where it is concluded in the step S10 that the Y coordinate value (y) satisfies −β≦y≦0 (step S10: YES) means the case where the input operation is performed on the split region 35. In this case, the CPU 11 performs processing in the step S11 to transform the coordinates subjected to the input operation into (x, n/2) so that the input operation performed on the split region 35 is regarded as an input operation performed on a small compartment which is the nearest to (x, y) in small compartments provided in the display region so as to be arranged along a side connecting the XY coordinates (0, 0) and (A, 0) and which is adjacent to the outer circumference of the display region.

On the other hand, when it is concluded in the step S10 that the Y coordinate value (y) does not satisfy −β≦y≦0 (step S10: NO), the CPU 11 determines whether the Y coordinate value (y) in the XY coordinates outputted from the detector 22 satisfies B≦y≦B+β or not (step S12).

When it is concluded in the step S12 that the Y coordinate value (y) satisfies B≦y≦B+β (step S12: YES), the CPU 11 transforms the coordinates subjected to the input operation into (x, B−n/2) (step S13).

The case where it is concluded in the step S12 that the Y coordinate value (y) satisfies B≦y≦B+β (step S12: YES) means the case where the input operation is performed on the split region 37. In this case, the CPU 11 performs processing in the step S13 to transform the coordinates subjected to the input operation into (x, B−n/2) so that the input operation performed on the split region 37 is regarded as an input operation performed on a small compartment which is the nearest to (x, y) in small compartments provided in the display region so as to be arranged along a side connecting the XY coordinates (0, B) and (A, B) and which is adjacent to the outer circumference of the display region.

On the other hand, when it is concluded in the step S12 that the Y coordinate value (y) does not satisfy B≦y≦B+β (step S12: NO), the CPU 11 transforms the coordinates subjected to the input operation into (x, y) (step S14).

The case where it is concluded in the step S12 that the Y coordinate value (y) does not satisfy B≦y≦B+β (step S12: NO) means the case where the input operation is performed on the split region 39, that is, the inside of the display region of the display 21. In this case, the CPU 11 directly uses the XY coordinates outputted from the detector 22.

When it is concluded in the step S9 that the X coordinate value (x) does not satisfy 0<x<A (step S9: NO), the CPU 11 determines whether the Y coordinate value (y) in the XY coordinates outputted from the detector 22 satisfies −β≦y≦0 or not (step S15).

When it is concluded in the step S15 that the Y coordinate value (y) satisfies −β≦y≦0 (step S15: YES), the CPU 11 transforms the coordinates subjected to the input operation into (A−m/2, n/2) (step S16).

The case where it is concluded in the step S15 that the Y coordinate value (y) satisfies −β≦y≦0 (step S15: YES) means the case where the input operation is performed on the split region 32. In this case, the CPU 11 performs processing in the step S16 to transform the coordinates subjected to the input operation into (A−m/2, n/2) so that the input operation performed on the split region 32 is regarded as an input operation performed on a small compartment in the display region (small compartment 43 shown in FIG. 5) which is the nearest to the XY coordinates (A, 0) and which is adjacent to the outer circumference of the display region.

On the other hand, when it is concluded in the step S15 that the Y coordinate value (y) does not satisfy −β≦y≦0 (step S15: NO), the CPU 11 determines whether the Y coordinate value (y) in the XY coordinates outputted from the detector 22 satisfies B≦y≦B+β or not (step S17).

When it is concluded in the step S17 that the Y coordinate value (y) satisfies B≦y≦B+β (step S17: YES), the CPU 11 transforms the coordinates subjected to the input operation into (A−m/2, B−n/2) (step S18).

The case where it is concluded in the step S17 that the Y coordinate value (y) satisfies B≦y≦B+β (step S17: YES) means the case where the input operation is performed on the split region 33. In this case, the CPU 11 performs processing in the step S18 to transform the coordinates subjected to the input operation into (A−m/2, B−n/2) so that the input operation performed on the split region 33 is regarded as an input operation performed on a small compartment in the display region (small compartment 44 shown in FIG. 5) which is the nearest to the XY coordinates (A, B) and which is adjacent to the outer circumference of the display region.

On the other hand, when it is concluded in the step S17 that the Y coordinate value (y) does not satisfy B≦y≦B+β (step S17: NO), the CPU 11 transforms the coordinates subjected to the input operation into (A−m/2, y) (step S19).

The case where it is concluded in the step S17 that the Y coordinate value (y) does not satisfy B≦y≦B+β (step S17: NO) means the case where the input operation is performed on the split region 38. In this case, the CPU 11 performs processing in the step S19 to transform the coordinates subjected to the input operation into (A−m/2, y) so that the input operation performed on the split region 38 is regarded as an input operation performed on a small compartment which is the nearest to (x, y) in small compartments provided in the display region so as to be arranged along a side connecting the XY coordinates (A, 0) and (A, B) and which is adjacent to the outer circumference of the display region.

After processing in any one of the steps S5, S7, S8, S11, S13, S14, S16, S18 and S19, the CPU 11 outputs the determined XY coordinates (step S20).

In this manner, when an input operation on the outside of the display region of the display 21 is detected, the CPU 11 performs coordinate transformation processing for regarding the input operation as an input operation on the inside of the display region. On this occasion, when the coordinates of the input operation on the outside of the display region is detected by the detector, the CPU 11 functions as a controller which transforms the coordinates of the input operation on the outside of the display region into the coordinates of the inside of the display region.

As described above, in the portable terminal 1, when coordinates of an input operation on the outside of the display region of the display 21 of the touch panel 19 is detected, the CPU 11 transforms the coordinates of the input operation into coordinates of the inside of the display region.

Consequently, even if the user performs an input operation on the outside of the display region by mistake when the user wants to perform an input operation for an input operation target in the display region disposed closely to the outer circumference of the display region, the input operation is automatically regarded as an input operation in the display region. Accordingly, it is possible to solve the problem that it may be difficult to perform an input operation on the outer circumference of the display region or the vicinity of the outer circumference in a touch panel according to the background art, so that it is possible to perform an input operation well on the outer circumference of the display region or the vicinity of the outer circumference.

Moreover, the CPU 11 divides the display region of the display 21 into small compartments by a width of m in the X direction and by a width of n in the Y direction, and transforms the coordinates of the input operation on the outside of the display region into coordinates of a small compartment which is inside the display region and which is adjacent to the outer circumference of the display region, based on the size of each small compartment.

Consequently, even if the user performs an input operation on the outside of the display region by mistake because of displacement of the position of the input operation when the user wants to perform an input operation on a small compartment adjacent to the outer circumference of the display region, the input operation is automatically regarded as an input operation on a small compartment adjacent to the outer circumference of the display region. Accordingly, the user can perform an input operation well on a small compartment adjacent to the outer circumference of the display region.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

Although the exemplary embodiment has been described in the case where the detector 22 is provided so that an input operation on the outside of the outer circumference of the display region can be detected in addition to detection of an input operation in a range corresponding to the display region of the display 21, a display region inside detector for detecting an input operation in a range corresponding to the display region of the display 21 and a display region outside detector for detecting an input operation on the outside of the outer circumference of the display region may be provided separately.

Although the exemplary embodiment has been described in the case where the display region is divided into small compartments by a width of m in the X direction and by a width of n in the Y direction, the size of each small compartment may be selected in use in accordance with the contents of the display screen. In this case, for example, combination of values of m and n for determining the size of each small compartment may be stored in advance in a storage device such as an ROM so that the CPU 11 can use m and n for the small compartment corresponding to the display contents in accordance with one of various kinds of display screens.

Although the exemplary embodiment has been described in the case where when an operation on the outside of the display region is performed, control is made so that the position of the input operation is regarded as a position corrected inward from the outer circumference of the display region by halves (m/2, n/2) of widths for division of the display region into small compartments, this is only one instance and other values may be used. For example, the degree of correction based on m and n may be changed to m/3 and n/3 or the position of the input operation may be corrected inward by predetermined coordinate values from the outer circumference.

Alternatively, the display region need not be divided equally into small compartments. For example, when a scroll bar is displayed along a side of the outer circumference of the display region, small compartments corresponding to the configuration (e.g. width, etc.) of the scroll bar may be provided for a portion of the display region where the scroll bar is displayed, while small compartments corresponding to the display contents may be provided for the other portion of the display region than the portion where the scroll bar is displayed. Alternatively, sizes of small compartments may be set suitably in accordance with sizes of icons, various kinds of buttons, etc. displayed in the small compartments respectively.

The invention can be applied not only to the portable terminal but also to any apparatus such as a desktop computer having a touch panel

The coordinate transformation processing performed by the input device described in the exemplary embodiment, that is, the flow chart of the coordinate transformation processing shown in FIG. 6 may be stored as a computer-executable program in a recording medium such as a memory card (e.g. an ROM card, an RAM card, etc.), a magnetic disk (e.g. a floppy disk, a hard disk, etc.), an optical disk (e.g. a CD-ROM, a DVD, etc.), a semiconductor memory etc. The computer (CPU 11) of the input device reads the program recorded on the recording medium into the RAM 12 and the operation thereof is controlled by the read program to thereby achieve the function of the coordinate transformation processing described in the exemplary embodiment.

What is claimed is:

1. An input device comprising:
a display configured to display information on a screen;
a detector configured to detect a user input operation in a detectable region of the detector and acquire position coordinates of the user input operation, wherein the detectable region is larger than a display region of the display, and the display region is included in the detectable region; and
a controller configured to transform the position coordinates of the user input operation,
wherein when the detector detects the user input operation in the detectable region other than the display region and acquires position coordinates of the user input operation, the controller transforms the position coordinates into position coordinates corresponding to a certain position in the display region, and
wherein when the detector detects the user input operation in the display region and acquires position coordinates of the user input operation, the controller sets the acquired position coordinates as position coordinates of the user input operation without transforming the acquired position coordinates.

2. The device according to claim 1,
wherein the display region is divided into a plurality of compartments, and
wherein the controller transforms the position coordinates into position coordinates corresponding to a certain position in one of the compartments which is adjacent to a portion of an outer circumference of the display region.

3. An input method for input device, the method comprising:
(a) displaying information on a screen;
(b) detecting a user input operation in a detectable region of the detector and acquiring position coordinates of the user input operation, wherein the detectable region is larger than a display region of the display, and the display region is included in the detectable region;
when detecting the user input operation in the detectable region other than the display region and acquiring position coordinates of the user input operation,
(c) transforming the position coordinates into position coordinates corresponding to a certain position in the display region; and
when detecting the user input operation in the display region and acquiring position coordinates of the user input operation,
(d) setting the acquired position coordinates as position coordinates of the user input operation without transforming the acquired position coordinates.

4. The method according to claim 3,
wherein the display region is divided into a plurality of compartments, and
wherein step (c) comprises: transforming the position coordinates into position coordinates corresponding to a certain position in one of the compartments which is adjacent to a portion of an outer circumference of the display region.

5. A computer-readable medium storing a program for causing the computer to perform predetermined operations, the operations comprising:
(a) displaying information on a screen;
(b) detecting a user input operation in a detectable region of the detector and acquiring position coordinates of the user input operation, wherein the detectable region is larger than a display region of the display, and the display region is included in the detectable region;
when detecting the user input operation in the detectable region other than the display region and acquiring position coordinates of the user input operation,
(c) transforming the position coordinates into position coordinates corresponding to a certain position in the display region; and
when detecting the user input operation in the display region and acquiring position coordinates of the user input operation,
(d) setting the acquired position coordinates as position coordinates of the user input operation without transforming the acquired position coordinates.

6. The computer-readable medium according to claim 5,
wherein the display region is divided into a plurality of compartments, and
wherein operation (c) comprises: transforming the position coordinates into position coordinates corresponding to a certain position in one of the compartments which is adjacent to a portion of an outer circumference of the display region.

7. The device according to claim 1, wherein the detector and the display constitute a touch panel configured to receive a user touching operation on the touch panel, and
the detector is configured to detect the user touching operation in the detectable region, and acquire position coordinates of the user touching operation.
